(19) United States
(12) Patent Application Publication
(10) Pub. No.: US 2025/0321241 A1
(43) Pub. Date: Oct. 16, 2025

(54) METHODS AND APPARATUS FOR DETERMINING A VIEWPOINT FOR INSPECTING A SAMPLE WITHIN A SAMPLE CONTAINER

(71) Applicant: Siemens Healthcare Diagnostics Inc., Tarrytown, NY (US)

(72) Inventors: Nikhil Shenoy, West Windsor, NJ (US); Yao-Jen Chang, Princeton, NJ (US); Ankur Kapoor, Plainsboro, NJ (US); Benjamin S. Pollack, Jersey City, NJ (US)

(73) Assignee: Siemens Healthcare Diagnostics Inc., Tarrytown, NY (US)

(21) Appl. No.: 18/866,353

(22) PCT Filed: May 23, 2023
(86) PCT No.: PCT/US2023/023175

§ 371 Date: Nov. 15, 2024

Related U.S. Application Data
(60) Provisional application No. 63/365,189, filed on May 23, 2022.

(51) Int. Cl. G01N 35/00

(52) U.S. Cl. CPC G01N 35/00732; G01N 2035/00752

(57) ABSTRACT

In some embodiments, a method of determining a viewpoint for optically inspecting a sample within a sample container is provided that includes (a) employing a sensor to capture image data of a sample container including a sample, wherein a portion of the sample container includes a label having first and second ends; (b) rotating at least one of the sample container and the sensor about a central axis of the sample container so that the sensor capture s image data including at least the first and second ends of the label; (c) employing the captured image data to generate an unwrapped image of the sample container; (d) processing the unwrapped image to characterize the label and produce label characterization information; and (e) employing the label characterization information to identify a viewpoint through which to optically inspect the sample within the sample container. Numerous other aspects are provided.

### CROSS REFERENCE TO RELATED APPLICATION

This application claims the benefit of U.S. Provisional Patent Application No. 63/365,189, entitled “METHODS AND APPARATUS FOR DETERMINING A VIEWPOINT FOR INSPECTING A SAMPLE WITHIN A SAMPLE CONTAINER” filed May 23, 2022, the disclosure of which is hereby incorporated by reference in its entirety for all purposes.

### FIELD

The present disclosure relates to methods and apparatus for testing of a sample, and, more particularly to methods and apparatus for sample analysis and viewpoint determination.

### BACKGROUND

Automated testing systems may be used to conduct clinical chemistry or assay testing using one or more reagents to identify an analyte or other constituent in a sample such as urine, blood serum, blood plasma, interstitial liquid, cerebrospinal liquids, or the like. For convenience and safety reasons, these samples may be contained within sample containers (e.g., blood collection tubes). The assay or test reactions generate various changes that may be read and/or manipulated to determine a concentration of analyte or other constituent present in the sample.

Improvements in automated testing technology have been accompanied by corresponding advances in pre-analytical sample preparation and handling operations such as sorting, batch preparation, centrifuging of sample containers to separate sample constituents, cap removal to facilitate sample access, and the like by automated, pre-analytical, sample preparation systems, which may be part of a Laboratory Automation System (LAS). The LAS may automatically transport samples in sample containers to one or more pre-analytical sample processing stations as well as to analyzer stations containing clinical chemistry analyzers and/or assay instruments (hereinafter collectively “analyzers”).

These LASs may handle processing of a number of different samples at one time, which may be contained in barcode-labeled or otherwise-labeled (hereinafter “labeled”) sample containers. The label may contain an accession number that may be correlated to demographic information entered into a hospital's Laboratory Information System (LIS) along with test orders and/or other information. An operator may place the labeled sample containers onto the LAS system, which may automatically route the sample containers for one or more pre-analytical operations such as centrifugation, decapping, and aliquot preparation, and all prior to the sample actually being subjected to clinical analysis or assaying by one or more analyzers that may be part of the LAS.

A sample quality check is an essential pre-analytical task for ensuring the validity of tests to be conducted on a sample inside a sample container. For example, the presence of an interferent (e.g., hemolysis, icterus, and/or lipemia) in a sample, which may result from a patient condition or sample pre-processing, may adversely affect test results of the analyte or constituent measurement obtained from one or more analyzers. The presence of hemolysis (H) in a sample, which may be unrelated to a patient's disease state, may cause a different interpretation of the disease condition of the patient. Similarly, the presence of icterus (I) and/or lipemia (L) in a sample may also cause a different interpretation of the disease condition of the patient.

Image analytics are commonly employed in laboratory automation systems to determine sample quality. However, optical perception can be easily impacted by various attributes of a sample container, such as container material, HIL interference, label condition, and/or sample container orientation. For example, labels on sample containers may scatter light, and cylindrical sample containers may behave as lens with optical properties that depend significantly on sample container orientation. Therefore, it is beneficial to find the optimal orientation for the specific sample quality check to be performed; and there is a need for methods and apparatus for determining an optimal viewpoint for inspecting a sample within a sample container.

### SUMMARY

In some embodiments, a method of determining a viewpoint for optically inspecting a sample within a sample container includes (a) employing a sensor to capture image data of a sample container including a sample, wherein a portion of the sample container includes a label having a first end and a second end; (b) rotating at least one of the sample container and the sensor about a central axis of the sample container so that the sensor captures image data that includes at least the first end of the label and the second end of the label; (c) employing the captured image data to generate an unwrapped image of the sample container; (d) processing the unwrapped image to characterize the label and produce label characterization information; and (e) employing the label characterization information to identify a viewpoint through which to optically inspect the sample within the sample container.

In some embodiments, an apparatus adapted to determine a viewpoint for optically inspecting a sample within a sample container is provided. The apparatus includes a sensor configured to capture image data of a sample container including a sample, wherein a portion of the sample container includes a label having a first end and a second end. The apparatus also includes a rotation mechanism configured to rotate at least one of the sample container and the sensor about a central axis of the sample container so that the sensor captures image data that includes at least the first end of the label and the second end of the label. The apparatus further includes a computer coupled to the sensor and the rotation mechanism, the computer including computer program code that, when executed by the computer, causes the computer to (a) direct the rotation mechanism to rotate at least one of the sample container and the sensor about the central axis of the sample container so that the sensor captures image data that includes at least the first end of the label and the second end of the label; (b) employ the captured image data to generate an unwrapped image of the sample container; (c) process the unwrapped image to characterize the label and produce label characterization information; and (d) employ the label characterization information to identify a viewpoint through which to optically inspect the sample within the sample container.

In some embodiments, a diagnostic analysis system includes (a) a track; (b) a carrier moveable on the track and configured to contain a sample container including a sample, wherein a portion of the sample container includes a label having a first end and a second end; (c) a sensor configured to capture image data of the sample container; (d) a rotation mechanism configured to rotate at least one of the sample container and the sensor about a central axis of the sample container so that the sensor captures image data that includes at least the first end of the label and the second end of the label; and (e) a computer coupled to the sensor and the rotation mechanism. The computer includes computer program code that, when executed by the computer, causes the computer to (i) direct the rotation mechanism to rotate at least one of the sample container and the sensor about the central axis of the sample container so that the sensor captures image data that includes at least the first end of the label and the second end of the label; (ii) employ the captured image data to generate an unwrapped image of the label; (iii) process the unwrapped image to characterize the label and produce label characterization information; and (iv) employ the label characterization information to identify a viewpoint through which to optically inspect the sample within the sample container.

Other features, aspects, and advantages of embodiments in accordance with the present disclosure will become more fully apparent from the following detailed description, the subjoined claims, and the accompanying drawings by illustrating a number of example embodiments and implementations. Various embodiments in accordance with the present disclosure may also be capable of other and different applications, and its several details may be modified in various respects, all without departing from the spirit and scope of the claims. Accordingly, the drawings and descriptions are to be regarded as illustrative in nature, and not as restrictive. The drawings are not necessarily drawn to scale.

### BRIEF DESCRIPTION OF THE DRAWINGS

The drawings, described below, are for illustrative purposes and are not necessarily drawn to scale. Accordingly, the drawings and descriptions are to be regarded as illustrative in nature, and not as restrictive. The drawings are not intended to limit the scope of the invention in any way.

FIG. 1 illustrates an automated diagnostic analysis system capable of automatically processing multiple sample containers containing samples in accordance with embodiments provided herein.

FIG. 2 illustrates a side view of a sample container that may include a separated sample with a serum or plasma portion that may contain an interferent in accordance with embodiments provided herein.

FIG. 3 illustrates a side view of the sample container of FIG. 2 held in an upright orientation in a holder that can be transported within the automated diagnostic analysis system of FIG. 1 in accordance with embodiments provided herein.

FIGS. 4A and 4B illustrate an example a quality check module configured to carry out methods as shown and described herein.

FIG. 5 illustrates a functional quality check module architecture configured to carry out characterization of a sample carrier and/or sample in accordance with embodiments provided herein.

FIG. 6 illustrates a method for determining a viewpoint for optically inspecting a sample within a sample container in accordance with embodiments provided herein.

FIG. 7A illustrates a motor system for rotating a sample container in accordance with embodiments provided herein.

FIGS. 7B-7F illustrate the capture of multiple images from multiple viewpoints around a sample container in accordance with embodiments provided herein.

FIG. 7G illustrates generation of an unwrapped image label from the multiple captured images of FIGS. 7B-7F in accordance with embodiments provided herein.

FIG. 8 illustrates use of a segmentation network to generate a segmentation mask in accordance with embodiments provided herein.

FIG. 9 illustrates identification of a suitable viewpoint based on the segmentation mask of FIG. 8 in accordance with embodiments provided herein.

FIG. 10A illustrates an embodiment of a segmentation network in which an input image is processed through a feature extractor and a segmentor in accordance with embodiments provided herein.

FIG. 10B illustrates an embodiment of a classification network in which an input image is processed through a feature extractor and classification section in accordance with embodiments provided herein.

FIG. 10C illustrates an embodiment of a segmentation and classification network in which an input image is processed through a feature extractor and both a segmentor and classification section in accordance with embodiments provided herein

### DETAILED DESCRIPTION

Many variations may occur within a sample handling system that may change a sample container's orientation, such as misplacement by a human technician on the initial entry, or rotations by machinery when moving the sample container from one location to another (e.g., such as when moving between pre-analytical processing stations or analyzer stations). In addition, defects in any labels placed on the sample container, such as skew, bunching, and tearing, may block most of the contents of the sample container from view. In spite of all these complicating factors, the sample handling system must determine the best way to orient the sample container in front of an optical analysis system to generate an accurate analysis of sample container contents. Correct placement of a sample container may lead to a more accurate understanding of a sample's components and may improve the performance of downstream tasks such as chemistry analysis, resulting in greater insight into a patient's health.

Embodiments provided herein include methods and apparatus for more accurately determining a viewpoint for optically inspecting a sample within a sample container despite variations in the rotation of the sample container or the presence of or defects in one or more labels on the sample container.

In one or more embodiments, multiple images of a sample container are obtained by an imaging sensor as the sample container rotates in front of the imaging sensor and/or the imaging sensor rotates around the sample container (e.g., obtaining images from 360 degrees around the sample container in some embodiments). The images may be snapshots of the sample container or frames extracted from a video. Thereafter, the images are stitched together to produce an unwrapped image depicting the sample container and any label thereon, and if a label is present, both ends of the label and any gap therebetween. The unwrapped image then may be processed to characterize the label, such as by passing the unwrapped image through a segmentation network to generate a segmentation mask which represents unwrapped image pixels as either label pixels or non-label pixels. The segmentation mask may be used to identify a gap between the ends of the label and the center (e.g., midpoint) of the gap between the label's ends may be determined and serve as a viewpoint for inspecting a sample within the sample container. How far the sample container (or the imaging sensor) should be rotated to align the identified viewpoint (e.g., the center of the label gap) with a center of view of the imaging sensor may be determined (e.g., for optical analysis of any sample within the sample container). Thereafter, the sample in the sample container may be inspected using the identified viewpoint, and the sample may be characterized.

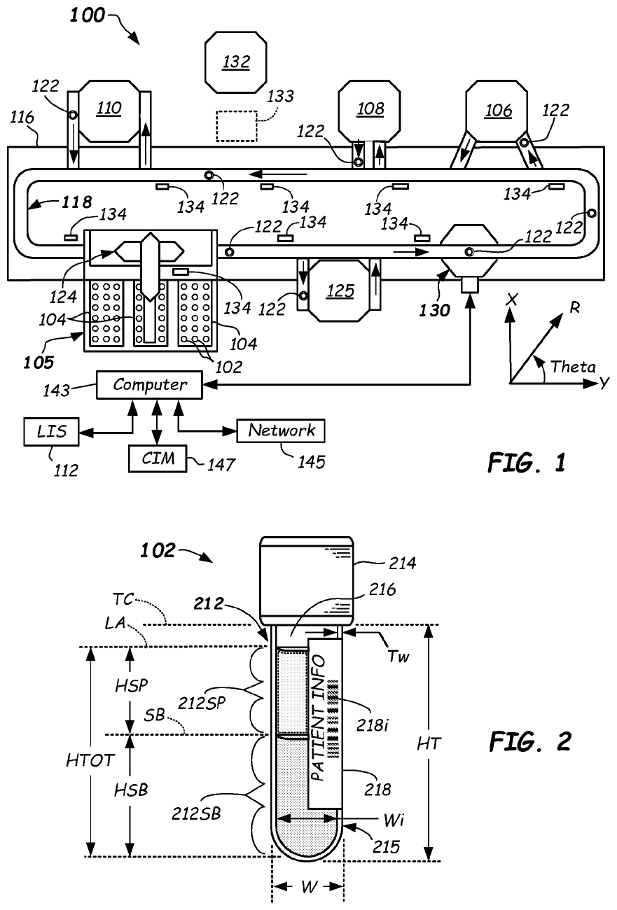

These and other embodiments are described below with reference to FIGS. 1-10C.

FIG. 1 illustrates an automated diagnostic analysis system 100 capable of automatically processing multiple sample containers 102 containing samples 212 (see FIG. 2). The sample containers 102 may be provided in one or more racks 104 at a loading area 105 prior to transportation to, and analysis by, one or more analyzers (e.g., first analyzer 106, second analyzer 108, and/or third analyzer 110) arranged about the automated diagnostic analysis system 100. More or fewer analyzers may be used in the system 100. The analyzers may be any combination of any number of clinical chemistry analyzers, assaying instruments, and/or the like. The term “analyzer” as used herein means a device used to analyze for chemistry or to assay for the presence, amount, or functional activity of a target entity (the analyte), such as DNA or RNA, for example. Analytes commonly tested for in clinical chemistry analyzers include enzymes, substrates, electrolytes, specific proteins, drugs of abuse, and therapeutic drugs. The sample containers 102 may be any suitably transparent or translucent containers, such as blood collection tubes, test tubes, sample cups, cuvettes, or other clear or opaque glass or plastic containers capable of containing and allowing imaging of the sample 212 contained therein. The sample containers 102 may be varied in size and may have different cap colors and/or cap types.

Samples 212 (see FIG. 2) may be provided to the automated diagnostic analysis system 100 in the sample containers 102, which may be capped with caps 214. The caps 214 may be of different types and/or colors (e.g., red, royal blue, light blue, green, grey, tan, yellow, or color combinations), which may have meaning in terms of what test each sample container 102 is used for, the type of additive included therein, whether the container includes a gel separator, or the like. Other colors may be used. In one or more embodiments, the cap type may be determined by a characterization method described herein. Cap type may be used to determine if the sample 212 is provided under a vacuum and/or the type of additive therein, for example. In FIG. 2, sample container 102 is shown as a tube 215. Other sample container shapes and/or types may be used.

Each of the sample containers 102 may be provided with one or more labels 218 that may include identification information 218i (i.e., indicia) thereon, such as a barcode, alphabetic characters, numeric characters, or combinations thereof. Example identification information 218i may include or be associated to (e.g., through a Laboratory Information System (LIS) 112 database as shown in FIG. 1), patient information (e.g., name, date of birth, address, and/or other personal information), tests to be performed, time and date the sample was obtained, medical facility information, tracking and routing information, etc. Other information may also be included. The identification information 218i may be machine readable at various locations about the automated diagnostic analysis system 100. The machine-readable information may be darker (e.g., black) than the label material (e.g., white paper) so that it can be readily imaged, for example. The identification information 218i may indicate, or may otherwise be correlated to, via the LIS 112 or other test ordering system, a patient's identification as well as tests to be performed on the sample 212. Such identification information 218i may be provided on the label 218, which may be adhered to or otherwise provided on an outside surface of the tube 215. As shown in FIG. 2, the label 218 may not extend all the way around the sample container 102 or all along a length of the sample container 102 such that from the particular lateral front viewpoint shown, some or a large part of a sample 212 (e.g., a serum or plasma portion 212SP, for example) is viewable (the part shown as dotted) and unobstructed by the label 218.

The sample 212 may include any fluid to be tested and/or analyzed (e.g., blood serum, blood plasma, urine, interstitial fluid, cerebrospinal fluid, or the like). In some embodiments, the sample 212 may include the serum or plasma portion 212SP and a settled blood portion 212SB contained within the tube 215. Air 216 may be provided above the serum and plasma portion 212SP and a line of demarcation between them is defined as the liquid-air interface (LA). The line of demarcation between the serum or plasma portion 212SP and the settled blood portion 212SB is defined as a serum-blood interface (SB). An interface between the air 216 and cap 214 is defined as a tube-cap interface (TC). The height of the tube (HT) is defined as a height from a bottom-most part of the tube 215 to a bottom of the cap 214 and may be used for determining tube size (tube height). A height of the serum or plasma portion 212SP is HSP and is defined as a height from a top of the serum or plasma portion 212SP at LA to a top of the settled blood portion 212SB at SB. A height of the settled blood portion 212SB is HSB and is defined as a height from the bottom of the settled blood portion 212SB to a top of the settled blood portion 212SB at SB. HTOT is a total height of the sample 212 and equals HSP plus HSB.

In more detail, automated diagnostic analysis system 100 may include a base 116 (FIG. 1) (e.g., a frame, floor, or other structure) upon which a track 118 may be mounted. The track 118 may be a railed track (e.g., a monorail or a multiple rail), a collection of conveyor belts, conveyor chains, moveable platforms, or any other suitable type of conveyance mechanism. Track 118 may be circular or any other suitable shape and may be a closed track (e.g., endless track) in some embodiments. Track 118 may, in operation, transport individual ones of the sample containers 102 to various locations spaced about the track 118 in carriers 122.

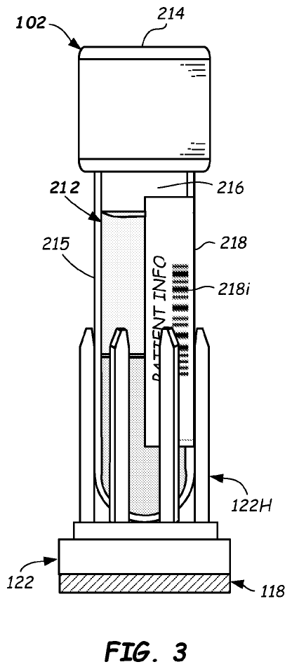

Carriers 122 may be passive, non-motored pucks that may be configured to carry a single sample container 102 on the track 118, or optionally, an automated carrier including an onboard drive motor, such as a linear motor that is programmed to move about the track 118 and stop at pre-programmed locations. Other configurations of carrier 122 may be used. Carriers 122 may each include a holder 122H (see FIG. 3) configured to hold the sample container 102 in a defined upright position and orientation. The holder 122H (FIG. 3) may include a plurality of fingers or leaf springs that secure the sample container 102 on the carrier 122, but some may be moveable or flexible to accommodate different sizes (widths) of the sample containers 102. In some embodiments, carriers 122 may leave from the loading area 105 (FIG. 1) after being offloaded from the one or more racks 104. The loading area 105 may serve a dual function of also allowing reloading of the sample containers 102 from the carriers 122 to the loading area 105 after pre-screening and/or analysis is complete.

A robot 124 may be provided at the loading area 105 and may be configured to grasp the sample containers 102 from the one or more racks 104 and load the sample containers 102 onto the carriers 122, such as onto an input lane of the track 118. Robot 124 may also be configured to reload sample containers 102 from the carriers 122 to the one or more racks 104. The robot 124 may include one or more (e.g., at least two) robot arms or components capable of X (lateral) and Z (vertical-out of the page, as shown), Y and Z, X, Y, and Z, or r (radial) and theta (rotational) motion. Robot 124 may be a gantry robot, an articulated robot, an R-theta robot, or other suitable robot wherein the robot 124 may be equipped with robotic gripper fingers oriented, sized, and configured to pick up and place the sample containers 102.

Upon being loaded onto track 118, the sample containers 102 carried by carriers 122 may progress to a first pre-processing station 125. For example, the first pre-processing station 125 may be an automated centrifuge configured to carry out fractionation of each sample 212. Carriers 122 carrying sample containers 102 may be diverted to the first pre-processing station 125 by an inflow lane or suitable robot. After being centrifuged, the sample containers 102 may exit on an outflow lane, or otherwise be removed by a robot, and continue along the track 118. In the depicted embodiment, the sample containers 102 in carriers 122 next may be transported to a quality check module 130 that is configured to carry out pre-screening, as will be further described herein.

The quality check module 130 is configured to pre-screen and carry out the one or more of the characterization methods described herein. For example, quality check module 130 may automatically determine a presence of, and optionally an extent or degree of H, I, and/or L contained in a sample 212 or whether the sample is normal (N). If found to contain effectively-low amounts of H, I and/or L, so as to be considered normal (N), the sample 212 may continue on the track 118 and then may be analyzed by the one or more analyzers (e.g., first, second, and/or third analyzers 106, 108, and/or 110). Other pre-processing operations may be conducted on the samples 212 and/or sample containers 102. After analysis by the one or more analyzers (e.g., first, second, and/or third analyzers 106, 108, and/or 110), the sample container 102 may be returned to the loading area 105 for reloading to the one or more racks 104 or otherwise offloaded.

In some embodiments, in addition to detection of HILN, segmentation of the sample container 102 and sample 212 may take place (e.g., at the quality check module 130). From the segmentation data, post processing may be used for quantification of the sample 212 (e.g., determination of HSP, HSB, HTOT, and/or possibly a determination of location of SB, LA and/or TC). In some embodiments, characterization of the physical attributes (e.g., size—height and width (or diameter)) of the sample container 102 may take place at the quality check module 130. Such characterization may include determining HT and W, and possibly TC, and/or Wi. From this characterization, the size of the sample container 102 may be extracted. Moreover, in some embodiments, the quality check module 130 may also determine cap type, which may be used as a safety check and may catch whether a wrong tube type has been used for the test or tests ordered.

In some embodiments, a remote station 132 may be provided on the automated diagnostic analysis system 100 that is not directly linked to the track 118. For instance, an independent robot 133 (shown dotted) may carry sample containers 102 containing samples 212 to the remote station 132 and return them after testing/pre-processing. Optionally, the sample containers 102 may be manually removed and returned. Remote station 132 may be used to test for certain constituents, such as a hemolysis level, or may be used for further processing, such as to lower a lipemia level through one or more additions and/or through additional processing, or to remove a clot, bubble, or foam, that is identified in the characterization at quality check module 130, for example. Other pre-screening using the HILN detection methods may optionally be accomplished at remote station 132.

Additional station(s) may be provided at one or more locations on or along the track 118. The additional station(s) may include a de-capping station, aliquoting station, one or more additional quality check modules 130, and the like.

The automated diagnostic analysis system 100 may include a number of sensors 134 at one or more locations around the track 118. Sensors 134 may be used to detect locations of sample containers 102 on the track 118 by means of reading the identification information 218i, or like information (not shown) provided on each carrier 122. Any suitable means for tracking the location may be used, such as proximity sensors. All of the sensors 134 may interface with a computer 143, so that the location of each sample container 102 along the track 118 may be known at all times.

The pre-processing station 125 and the analyzers 106, 108, and 110 may be equipped with robotic mechanisms and/or inflow lanes configured to remove carriers 122 from the track 118, and with robotic mechanisms and/or outflow lanes configured to reenter carriers 122 to the track 118.

Automated diagnostic analysis system 100 may be controlled by the computer 143, which may be a microprocessor-based central processing unit CPU or other suitable controller having a suitable memory and suitable conditioning electronics and drivers for operating the various system components. Computer 143 may be housed as part of, or separate from, the base 116 of the automated diagnostic analysis system 100. The computer 143 may operate to control movement of the carriers 122 to and from the loading area 105, motion about the track 118, motion to and from the first pre-processing station 125 as well as operation of the first pre-processing station 125 (e.g., centrifuge), motion to and from the quality check module 130 as well as operation of the quality check module 130, and motion to and from each analyzer 106, 108, 110. In some embodiments, the operation of each analyzer 106, 108, 110 for carrying out the various types of testing (e.g., assay or clinical chemistry) may be carried out by a local workstation computer at each analyzer 106, 108, 110 that is in digital communication with computer 143, such as through a network 145 (FIG. 1) such as a local area network (LAN) or wireless area network (WAN) or other suitable communication network. Optionally, the operation of some or all of the afore-mentioned analyzers 106, 108, 110 may be provided by computer 143.

For all but the quality check module 130, the computer 143 may control the automated diagnostic analysis system 100 according to software, firmware, and/or hardware commands or circuits such as those used on the Dimension® clinical chemistry analyzer sold by Siemens Healthcare Diagnostics Inc. of Tarrytown, New York. Other suitable systems for controlling the automated diagnostic analysis system 100 may be used. The control of the quality check module 130 may also be provided by the computer 143 (or another suitable computer) in accordance with the embodiments described in detail herein.

The computer 143 can be used for image processing and to carry out the characterization methods described herein. The computer may include a CPU or GPU, sufficient processing capability and RAM, and suitable storage, for example. In one example, the computer 143 may be a multi-processor-equipped PC with one or more GPUs, 8 GB RAM or more, and a Terabyte or more of storage. In another example, the computer 143 may be a GPU-equipped PC, or optionally a CPU-equipped PC operated in a parallelized mode. A Math Kernel Library (MKL) may be used as well, 8 GB RAM or more, and suitable storage.

Embodiments of the disclosure may be implemented using a computer interface module (CIM) 147 that allows a user to easily and quickly access a variety of control and status display screens. These control and status display screens may display and enable control of some or all aspects of a plurality of interrelated automated devices used for preparation, pre-screening, and analysis of samples 212. The CIM 147 may be employed to provide information about the operational status of a plurality of interrelated automated devices as well as information describing the location of any sample 212 and a status of pre-screening and test(s) to be performed on, or being performed on, the sample 212. The CIM 147 is thus adapted to facilitate interactions between an operator and the automated diagnostic analysis system 100. The CIM 147 may include, for example, a display screen operative to display a menu including icons, scroll bars, boxes, and/or buttons through which the operator may interface with the automated diagnostic analysis system 100. The menu may comprise a number of functional elements programmed to display and/or operate functional aspects of the automated diagnostic analysis system 100.

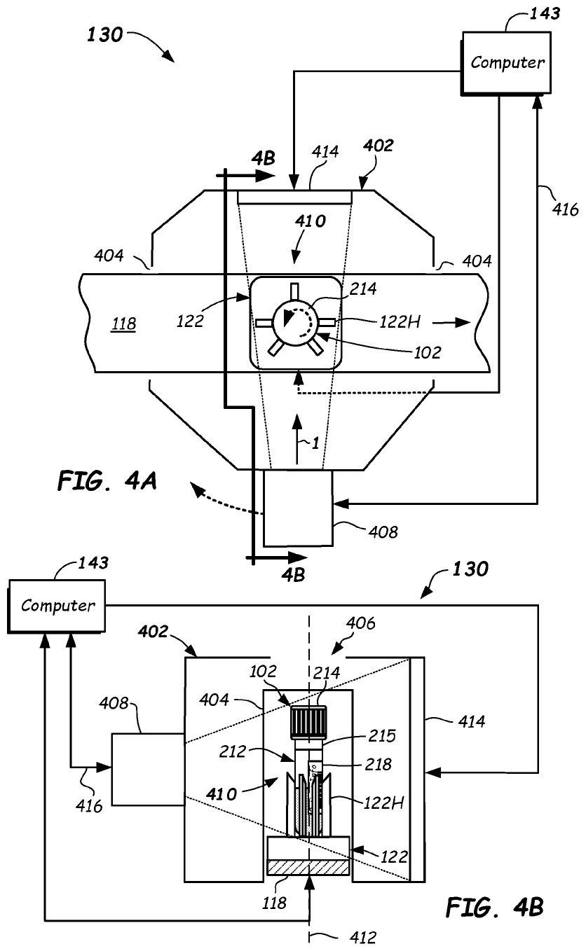

FIGS. 4A and 4B illustrate an embodiment of a quality check module 130 configured to carry out methods as shown and described herein. Quality check module 130 may be configured with programming instructions that, when executed by computer 143, perform a pre-screen to ensure the validity of tests to be conducted on the sample 212 within the sample container 102. For example, quality check module 130 may pre-screen for container material, label condition, sample container orientation, a presence of, and optionally, a degree of, an interferent (e.g., H, I, and/or L) in a sample 212 (e.g., in a serum or plasma portion 212SP thereof) prior to analysis by one or more of the analyzers 106, 108, 110, and/or the like. Pre-screening in this manner allows for additional processing, additional quantification or characterization, and/or discarding and/or redrawing of a sample 212 without wasting valuable analyzer resources or possibly having the presence of an interferent affect the veracity of the test results. Further, pre-screening may, in some aspects, enable improved characterization of future samples 212.

In addition to the interferent detection methods described herein, other detection methods may take place on the sample 212 contained in the sample container 102 at the quality check module 130. For example, a method may be carried out at the quality check module 130 to provide segmentation data. The segmentation data may be used in a post-imaging step to quantify the sample 212, e.g., to determine certain physical dimensional characteristics of the sample 212, such as the locations of LA and/or SB, and/or a determination of HSP, HSB, HT, Wi, and/or HTOT. Quantification may also involve estimating, e.g., a volume of the serum or plasma portion (VSP) and/or a volume of the settled blood portion (VSB) based upon quantification of the inner width Wi. Furthermore, the quality check module 130 may be used to quantify geometry of the sample container 102, i.e., quantify certain physical dimensional characteristics of the sample container 102, such as the location of TC, HT, and/or W or Wi of the sample container 102. Other quantifiable geometrical features may also be determined.

Quality check module 130 may include a housing 402 that may at least partially surround or cover the track 118 to minimize outside lighting influences. The sample container 102 may be located inside the housing 402 at an imaging location during the image-taking sequences. Housing 402 may include one or more doors 404 to allow the carriers 122 to enter into and/or exit from the housing 402. In some embodiments, the ceiling may include an opening 406 (FIG. 4B) to allow a sample container 102 to be loaded into the carrier 122 from above by a robot including moveable robot fingers.

As shown in FIGS. 4A and 4B, quality check module 130 may include an image capture device, referred to as sensor 408, configured to capture lateral images of the sample container 102 and sample 212 at an imaging location 410 from a viewpoint (e.g., a lateral viewpoint labeled 1). While one sensor 408 is shown, optionally two, three, four, or more can be used. The viewpoint 1 may be arranged in any suitable location. In some embodiments, sensor 408 may be configured to rotate relative to a central axis 412 (FIG. 4B) of sample container 102. For example, sensor 408 may rotate on a motor driven track (not shown) controlled by computer 143.

A light source 414 may back light the sample container 102 (as shown) for imaging to accomplish segmentation and/or HILN characterization. In other instances, such as for characterizing the sample container 102, front lighting the imaging location 410 may be used. In embodiments in which sensor 408 rotates, light source 414 may be configured to rotate relative to a central axis 412 of sample container 102 with sensor 408.

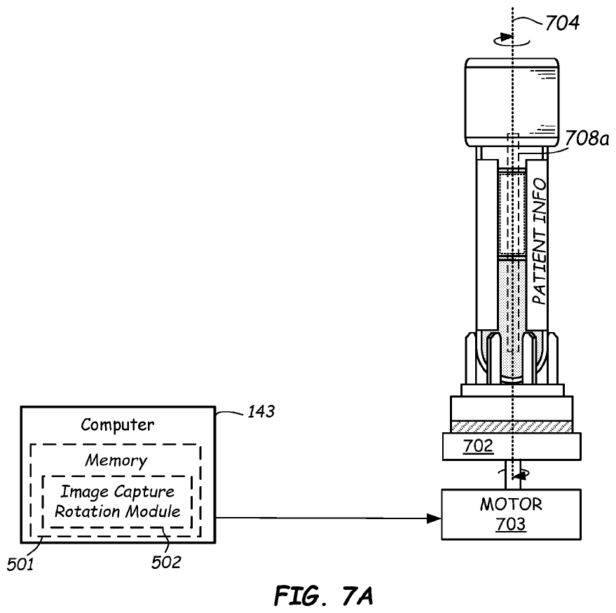

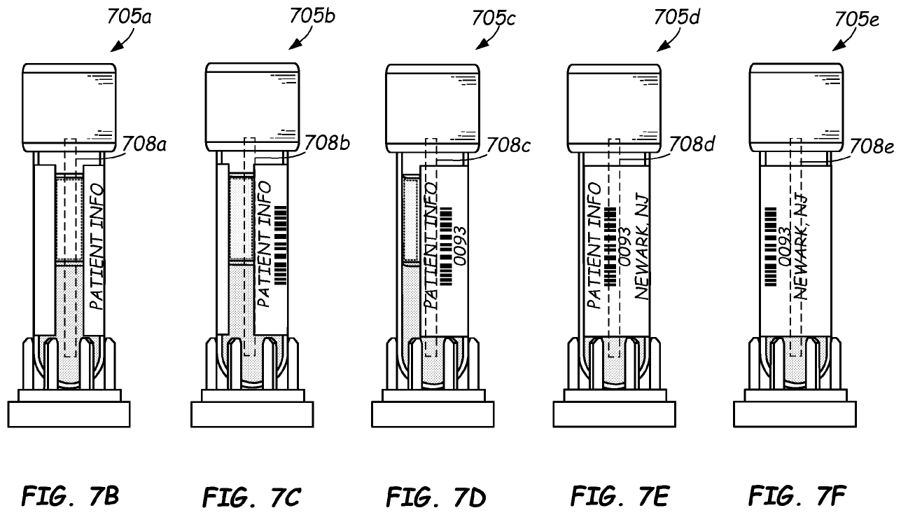

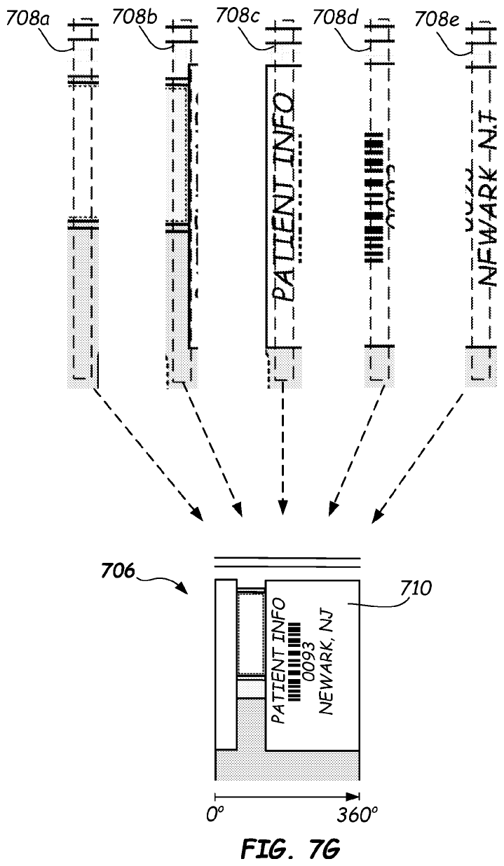

In one or more embodiments, sample carrier 122 may be caused to rotate within quality check module 130 during imaging of sample container 102 and sample 212. For example, a motor or other rotation mechanism (e.g., motor 703 of FIG. 7A) within quality check module 130 controlled by computer 143 (or another computer) may cause sample carrier 122 to rotate. In some embodiments, both sensor 408 and sample carrier 122 may rotate relative to one another. Rotation of sensor 408 and/or sample container 102 (via sample carrier 122) allows sample container 102 and sample 212 to be imaged from multiple viewpoints (e.g., with up to 360 degrees of rotation of sample container 102 relative to sensor 408 and up 360 degrees of imaging of sample container 102 and sample 212).

Through use of sensor 408, images of the sample 212 in the sample container 102 may be taken while the sample container 102 is residing in the carrier 122 at the imaging location 410. The field of view of the multiple images obtained by the sensor 408 may overlap in a circumferential extent. In some embodiments, portions of the images may be digitally added to arrive at a complete image of the sample 212 for analysis. In particular, in embodiments described below, multiple images captured by sensor 408 may be combined (e.g., stitched together) to form an unwrapped image of sample container 102 (and any label on sample container 102) and a viewpoint for imaging sample 212 may be determined. For example, in some embodiments, a slice or “window” with a width of a predetermined number of pixels and full (or other) image height may be obtained for each image and the slices may be sequentially concatenated together to generate the stitched image. Alternatively, in some embodiments, a percentage of a current image slice may be overlapped with a previous image slice. The final values for the pixels in the overlapping region may be a linear combination of the pixel values from the previous slice and the current slice, for example.

Sensor 408 may be any suitable device configured to capture well-defined digital images, such as a conventional digital camera capable of capturing a pixelated image, a charged coupled devices (CCD), an array of photodetectors, a CMOS sensor, or the like. The captured image size may be, e.g., about 2560×694 pixels, for example. In another embodiment, the sensor 408 may capture an image size that may be about 1280×387 pixels, for example. Other image sizes and pixel densities may be used for the captured images.

Each image may be triggered and captured at quality check module 130 in response to receiving a triggering signal provided in communication lines 416 from the computer 143. Each of the captured images may be processed by the computer 143 according to one or more embodiments. In some embodiments, high dynamic range (HDR) processing may be used to capture and process the image data from the captured images.

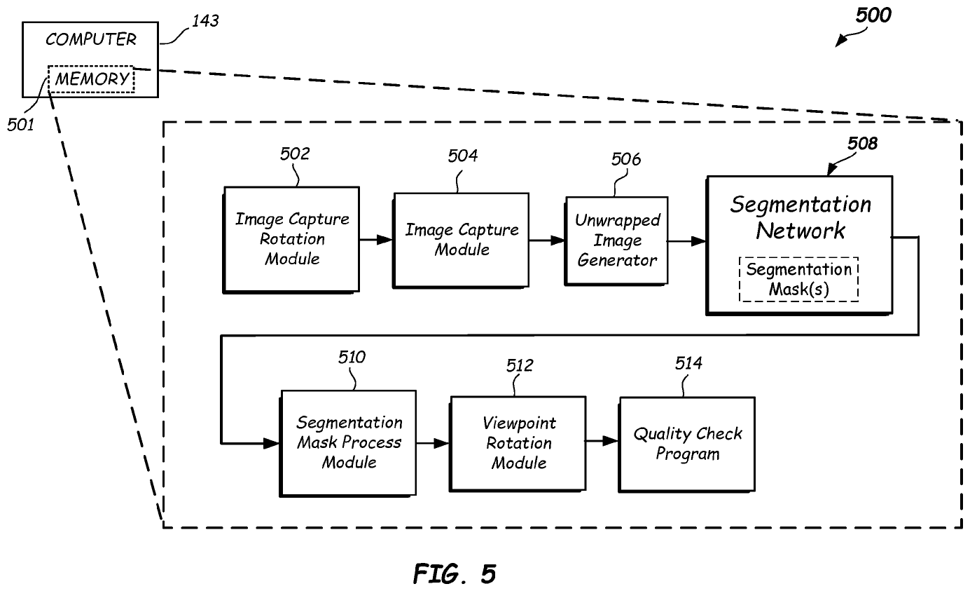

Operation of quality check module 130 is now described with reference to FIGS. 5-9.

FIG. 5 illustrates a functional quality check module architecture 500 configured to carry out characterization of a sample carrier and/or sample in accordance with embodiments provided herein. In some embodiments, functional quality check module architecture 500 may be implemented in quality check module 130 (FIG. 1) as computer programming instructions stored in a memory 501 of computer 143, for example. In general, functional quality check module architecture 500 may be implemented across one or more computing devices and/or one or more memories.

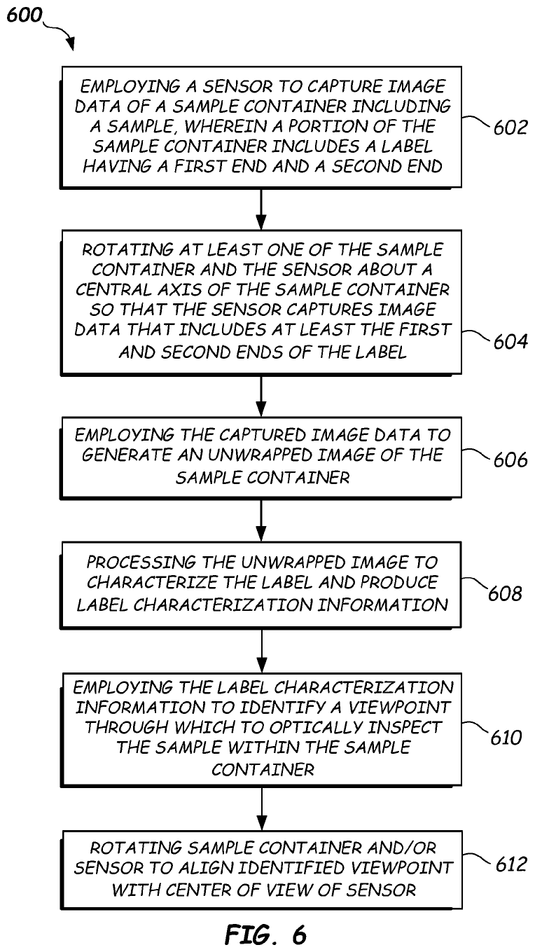

With reference to FIG. 5, functional quality check module architecture 500 includes an image capture rotation module 502 that controls rotation of sample container 102 and/or sensor 408 during imaging within quality check module 130. For example, image capture rotation module 502 may include programming instructions which direct one or more motors (e.g., motor 703 in FIG. 7A) to rotate sample container 102 and/or sensor 408 within quality check module 130. An image capture module 504 controls imaging within quality check module 130 (e.g., via programming instructions which direct sensor 408 when to take images of sample container 102). Images captured by sensor 408 are provided to unwrapped image generator 506 which includes programming instructions that combine the captured images to generate an unwrapped image of sample container 102 (and/or any label on sample container 102). Any suitable method for stitching images together may be employed, such as the imaging processing tools of Open-CV in Python (see, also, Matthew Brown and David G. Lowe, “Automated Panoramic Image Stitching using Invariant Features,” International Journal of Computer Vision 74 (2007)). The unwrapped image then may be fed through a segmentation network 508 that creates a segmentation mask based on the unwrapped image (as described further below). A segmentation mask is similar to the unwrapped image, but each pixel within the segmentation mask is identified as either a label pixel or a non-label pixel. A segmentation mask process module 510 includes programming instructions that analyze the segmentation mask and identify a gap between the ends of any unwrapped label on the sample container. In particular, a viewpoint may be identified within the label gap (e.g., a midpoint of the gap), as well as an amount sample container 102 (and/or sensor 408) should be rotated so that sensor 408 images sample container 102 through the identified viewpoint (e.g., so that the identified viewpoint aligns with a center of view of sensor 408). Quality check program 514 may then perform the desired quality check and/or characterization of sample container 102 and/or sample 212. Additional details regarding operation of functional quality check module architecture 500 are described below with reference to FIGS. 6-9.

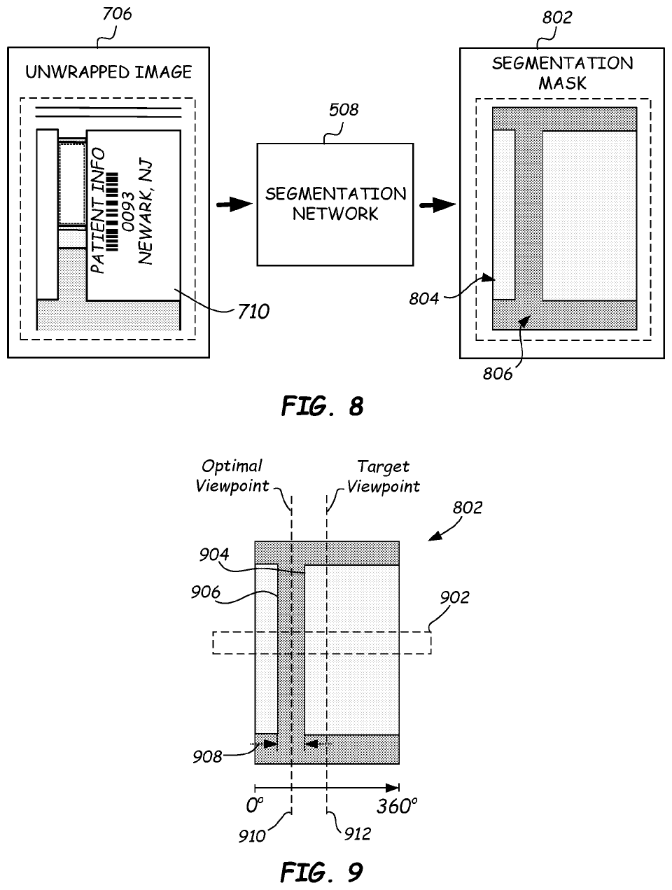

FIG. 6 illustrates a method 600 for determining a viewpoint for optically inspecting a sample within a sample container in accordance with embodiments provided herein. Method 600 is described with reference to FIGS. 7A-9 in which FIG. 7A illustrates a motor system for rotating a sample container, FIGS. 7B-7F illustrates the capture of multiple images from multiple viewpoints around a sample container, FIG. 7G illustrates generation of an unwrapped image from the multiple captured images of FIGS. 7B-7F, FIG. 8 illustrates use of a segmentation network to generate a segmentation mask, and FIG. 9 illustrates identification of a suitable viewpoint based on the segmentation mask of FIG. 8, each in accordance with embodiments provided herein.

With reference to FIG. 6, method 600 includes (1) at 602, employing a sensor to capture image data of a sample container including a sample, wherein a portion of the sample container includes a label having a first end and a second end; and (2) at 604, rotating at least one of the sample container and the sensor about a central axis of the sample container so that the sensor captures image data that includes at least the first end of the label and the second end of the label. For example, sample container 102 and/or sensor 408 may be rotated relative to one another while sensor 408 captures images of sample container 102 from multiple different viewpoints.

In some embodiments, sample container 102 may be rotated while sensor 408 remains stationary. For example, as shown in FIG. 7A, a rotating platform 702 (e.g., driven by a motor 703 controlled by image capture rotation module 502 (FIG. 5) of computer 143) may be used to securely hold sample container 102 and rotate it in place along the sample container's central axis 704. In this setup, sensor 408 may remain fixed with sample container 102 positioned in the center of the view of sensor 408 while sample container 102 is rotating. In some embodiments, sensor 408 and sample container 102 may be adjusted so that the entire sample container 102 is inside the field of view of sensor 408. External lighting, such as from light source 414 (FIG. 4A), may be applied to provide sufficient illumination based on the desired exposure time setting. Images captured during rotation of sample container 102 and/or sensor 408 may be stored (e.g., in memory 501 of computer 143 (FIG. 5)).

Five example images 705a-705e of sample container 102 taken from five different viewpoints (e.g., five different amounts of rotation) are shown in FIGS. 7B-7F. Additional or fewer images and/or viewpoints may be used. In some embodiments, sample container 102 and/or sensor 408 may be rotated relative to each other for a full 360 degrees of revolution. Larger or smaller degrees of rotation may be used (e.g., enough rotation to capture the gap between the ends of a label on sample container 102).

At 606, method 600 includes employing the captured image data to generate an unwrapped image of the sample container that includes the label (e.g., unwrapped image 706 as shown in 7G). Any suitable image composition algorithm may be employed to aggregate the images into a single image that represents the unwrapped label and/or sample container 102. In some embodiments, line scans in which small windows of the pixels of sample container 102 are extracted from each image (or from selected video frames) may be stitched together to form the unwrapped image 706. Example image windows 708a-708e are shown in FIGS. 7B-7F. Through use of a plurality of images, or over the course of an entire video, these smaller, image windows may capture the entire geometry of sample container 102. In some embodiments, approximately 2 to 360 image windows of a size ranging from approximately 1 to 20 mm in width by approximately 1 to 60 mm in height, or approximately 1 to 640 pixels in width by approximately 1 to 1920 pixels in height, may be used. In some embodiments, each image window 708a-e may represent about 0.4% to about 1.6% of the pixels of each image. Other numbers, widths, and/or lengths of image windows may be used. The size of the image windows employed may be dependent on numerous factors such as the capture rate of the image capture device employed, the resolution at which the image capture device is able to capture images, and how the sample container is oriented relative to the image capture device, for example.

Image windows 708a-e may be stitched and blended together in order to generate unwrapped image 706. The width of each image window may be altered depending on the geometry of sample container 102, such as based on how much curvature appears in each image. In some embodiments, not all frames of a video (or image snapshots) may be employed during image stitching. For example, it may be possible to selectively choose the frames from which each image window is extracted in order use a smaller set of images. The amount of image data input into the algorithm can be adjusted based on the relevant geometry. As mentioned, any suitable stitching algorithm may be employed and implemented in computer program instructions (e.g., executed by computer 143 as part of unwrapped image generator 506).

At 608, method 600 includes processing the unwrapped image to characterize the label (and produce label characterization information). For example, unwrapped image 706 may be analyzed to determine label characterization information such as which parts of the image are the label (label 710 in FIG. 7G) and which are not, the location of the ends of the label, the size of the gap between the ends of a label, the location of the label on the sample container, or the like. Information about label 710 and its location in the image may be used to determine the optimal orientation for the target task (as described below). The label characterization step extracts key features of label 710 that distinguish it from the rest of sample container 102 and the background of the image. In some embodiments, the unwrapped image 706 may be employed to generate a segmentation mask that characterizes the label. For example, the unwrapped image 706 may be processed through a deep-learning based segmentation network (e.g., segmentation network 508 in FIG. 8). Such a network may be trained to recognize a label in an unwrapped image of a sample container and generate a segmentation mask that identifies where the label is in the image. For example, as shown in FIG. 8, unwrapped image 706 may be fed into segmentation network 508 to generate segmentation mask 802.

Segmentation network 508 is trained to learn the physical characteristics of labels on sample containers within images acquired with the same setup as the training data (e.g., quality check module 130). Segmentation network 508 may be similar to a standard neural network. For example, an existing set of data (e.g., unwrapped images) may be provided to train the network. These images include unwrapped labels that may be annotated to indicate relevant information, such as the location of the bar code, edges of the label, other label indicia, tears or bunching of a label, or the like.

Segmentation network 508 may process an unwrapped image containing one or more labels and output an image of similar (or the same) height and width, with each pixel in the output image identified as a label pixel or a non-label pixel in the form of a segmentation mask, such as segmentation mask 802. For example, the lighter regions in segmentation mask 802 identify label pixels 804 while the darker regions identify non-label pixels 806. During training, the segmentation network 508 may be taught to produce accurate segmentation masks by adjusting internal connection weights so that unwrapped images used during training output the expected segmentation masks. In some embodiments, thousands of training images may be employed to train segmentation network 508 to produce accurate segmentation masks which identify label and non-label regions of unwrapped images. Training images may be generated, for example, by imaging numerous sample containers each with different label properties (e.g., different label gap sizes, flatness, bunching, orientation, etc.), as well as different sample container orientations. For each sample container, a set of training images may be generated by imagining many different regions of a sample container at different amounts of rotation and then stitching together sets of images to create a large number of unwrapped images for each sample container.

In some embodiments, segmentation network 508 may include a segmentation convolutional neural network (SCNN) that receives as input an unwrapped image of sample container 102. An SCNN may include, in some embodiments, greater than 100 operational layers including, e.g., BatchNorm, ReLU activation, convolution (e.g., 2D), dropout, and deconvolution (e.g., 2D) layers to extract features, such as edges, texture, and parts of any label present on the sample container 102. Top layers, such as fully convolutional layers, may be used to provide correlation between parts. A SoftMax layer may produce an output on a per pixel (or per patch—including n×n pixels) basis concerning whether each pixel or patch includes a label. In some embodiments, segmentation network 505 or a separate SCNN may include a front-end container segmentation network (CSN) to determine a sample container type and a container boundary. More particularly, the CSN may classify (or “segment”) various regions of the sample container and sample such as a serum or plasma portion, settled blood portion, gel separator (if used), air region, one or more label regions, type of specimen container (indicating, e.g., height and width/diameter), and/or type and/or color of a sample container cap. A sample container holder or background may also be classified. There may be cases in which an SCNN may perform all of these tasks without an additional CSN at the end. A CSN may be included in the SCNN in some embodiments. In other embodiments, a CSN may be used as a separate model after the SCNN.

At 610, method 600 includes employing the label characterization information (e.g., the segmentation mask) to identify a viewpoint through which to optically inspect the sample within the sample container. For example, once segmentation network 508 determines the segmentation mask 802 (e.g., performs label segmentation on unwrapped image 706), the output segmentation (segmentation mask 802) can be analyzed in segmentation mask process module 510 (FIG. 5) to determine an optimal viewpoint for imaging sample container 102 and sample 212 stored therein. Because unwrapping the image of label 710 (FIG. 7G) associates information about the geometry of sample container 102 with the rotation along the horizontal axis of the image 706, the location of key features in the unwrapped image 706 may be used to determine the current orientation of sample container 102. When acquiring the images used to generate unwrapped image 706, the initial position of sample container 102 during imaging may be considered as the 0-degree rotation, and the consecutive images may be mapped with the amount of rotation of sample container 102 (or sensor 408) based on how fast sample container 102 is rotated by motor 703. For example, computer 143 may monitor rotation of sample container 102 by motor 703 to determine how far sample container 102 is rotated between each image used to form unwrapped image 706. In this manner, horizontal pixels of unwrapped image 706 may be associated with a degree of rotation of sample container 102 as shown, for example, in FIG. 7G and segmentation mask 802 of FIG. 9. This rotation information may be stored, for example, in memory 501 of computer 143.

With reference to FIG. 9, in some embodiments, a horizontal window 902 (e.g., a segmentation slice) may be extracted from segmentation mask 802 for analysis. Horizontal window 902 contains information about where label 710 begins (at first end 904) and ends (at second end 906), and segmentation mask process module 510 (FIG. 5) may associate the gap 908 between the first and second ends 904 and 906 with a particular amount of rotation of sample container 102. The midpoint 910 between the first end 904 and second end 906 of label 710 may be determined from segmentation mask 802, along with the relative rotation required to rotate sample container 102 so that the midpoint 910 (e.g., center) of gap 908 aligns with a center of view 912 of sensor 408. In this manner, the optimal viewpoint for optically probing sample 212 within sample container 102 may be determined (e.g., the midpoint or center 910 of gap 908) and the amount of rotation required to align the optimal viewpoint with the center of view of sensor 408 may be obtained.

At 612 (FIG. 6), method 600 includes rotating the sample container and/or sensor to align the identified (e.g., optimal) viewpoint with the center of view of the sensor. For example, viewpoint rotation module 512 (FIG. 5) may be used to rotate sample container 102 so that midpoint 910 of label 710 (e.g., the identified and/or optimal viewpoint for characterizing sample 212 and/or sample container 102) and the center of view 912 of sensor 408 (also labelled as the “target viewpoint” in FIG. 9) align prior to performing a quality check operation on sample container 102 and/or sample 212. Alternatively or additionally, sensor 408 may be rotated about sample container 102 to align the identified (e.g., optimal) viewpoint with the center of view of sensor 408. In this manner, sample container 102 may be properly and/or optimally oriented in relation to sensor 408.

Following aligning of the identified viewpoint and the center of view of sensor 408, sample container 102 and/or sample 212 may be subjected to a quality check and/or otherwise characterized. For example, sample 212 may be optically analyzed for a presence of, and optionally, a degree of, an interferent (e.g., H, I, and/or L) in sample 212 (e.g., in a serum or plasma portion 212SP thereof) using the identified viewpoint prior to analysis by one or more of analyzers 106, 108, and/or 110. Sample container 102 also may be characterized and/or pre-screened for container material, label condition, or sample container orientation, prior to analysis by one or more of analyzers 106, 108, 110, and/or the like.

Label characterization is not limited to segmentation of label 710. Other relevant characteristics such as the dimensions of the barcode, the number of labels on the sample container, and/or the condition of the barcode also may be considered when determining the viewpoint. Using the detected physical dimensions of the label 710 and prior knowledge of the sample container's geometry, segmentation mask process module 510 (FIG. 5) and computer 143 may deduce the point where the label 710 was applied and how it wraps around the surface of the sample container 102. Based on the endpoint of the label 710 after wrapping, one can determine whether or not an opening (e.g., a gap between the ends the label) is present and, if an opening does exist, the width of the opening. This information allows determination of the optimal viewpoint.

The number of labels on a sample container and their locations may also be important to sample characterization as the label arrangement may occlude part or all of the analysis area. Labels may not be applied exactly the same way every time and may start and stop at different points along the sample container as well as be applied at different heights. This may cause labels to overlap with each other and obscure key areas of a sample container. Knowledge of the number of labels and the amount of overlap between them provides information about the size of the analysis area available and whether sample analysis is possible, and may be used to improve result accuracy. For this reason, segmentation network 508 may be trained with unwrapped images having multiple labels in varying arrangements.

The condition of labels may play an important role in sample analysis as well. During handling and processing of a sample container, interactions with a label on a sample container may cause the label to deviate from an ideal and/or freshly-applied state. For example, machinery handling a sample container may tear part of the label thereon, or cause the label to peel off of a surface of the sample container. In other cases, a label may bunch up when being applied, preventing the label from lying flat against the sample container. Such conditions may affect the appearance of a label and may confuse a model that is designed to only identify perfect labels. Incorporating information about the varying label conditions into the model (e.g., segmentation network 508) lets the model be robust to label deformations and other alterations that may occur in real-world scenarios. For these reasons, segmentation network 508 may be trained with unwrapped images having labels that are misplaced, torn, bunched and/or the like.

The placement of a sample container may also play a significant role in viewpoint detection. Variations in the shape of a sample container may cause it to appear tilted in an unwrapped image, shorter or longer than the average container, or either thicker or thinner than the average container. These types of variations may occur due to misplacement by robots or other handling equipment, or due to fitting the sample container into a holder that is not specifically designed for the sample container. Teaching the model (e.g., segmentation network 508) to be robust to disparities in the sample container's appearance safeguards it against abnormal placements while still providing accurate results. This adds to the flexibility of the model as it will still produce accurate results despite the variations that may occur in a real-world setting.

The binary segmentation of pixels of segmentation mask 802 between label and non-label pixels may be extended to a multi-class segmentation in which other parts of sample container 102 may be identified. Other parts of sample container 102 that may be identified include but are not limited to the fluid air interface, barcode, manufacturing label, cap, and more. The locations of these and other derived features from their segmentations may be used in conjunction with the midpoint described previously to determine the optimal viewpoint. For example, knowledge of other aspects of a sample container may be used to determine where to begin measuring the gap between the ends of a label. Knowing where other components are located on a sample container may assist in accurately determining the edges of a label in cases where different components may be overlapping. In some embodiments, a “covering” component may be subtracted from an image to obtain the actual label boundary.

In some embodiments, a series of acquired images taken at different viewpoints by sensor 408 may be employed to construct a three-dimensional (3D) model of sample container 102. The 3D model may provide an accurate characterization of container geometry and may be used to estimate additional characteristics such as the serum and red-blood cell volume. In this manner, the quality check module 130 may gain additional information about the fluid content and the geometry of sample container 102 during determination of the optimal viewpoint.

In one or more embodiments, instead of using a segmentation network for viewpoint detection, a classification or regression model may directly use one or more raw images. This may be achieved by, for example, either directly training a classification/regression network or by branching out segmentation network 508. In some embodiments, instead of generating an unwrapped image from a series of image captures, a classification network may be trained to directly predict the approximate amount of rotation required (e.g., to align a midpoint of a label gap with a center of view of a sensor used for image capture) by using one image from the series. This may remove the step of generating an unwrapped image. For example, the classification network may be trained to learn the nuances of a sample container's curvature from the captured images. This information may be useful in determining how much a sample container should rotate. Such a model may receive a captured image as input and return an indicator that refers to a class that identifies the required range of rotation for aligning a label gap with a center of view of an imaging sensor. In some embodiments, and as described further below, classes may be divided into groups of approximately 10 degrees (0-10, 10-20, etc.).

As a further example of a classification model approach, instead of using a segmentation network, another network may be employed to perform classification. For example, the 360-degree rotation of sample container 102 may be broken into discrete rotation regions (e.g., each 20 to 30 degrees to obtain approximately 10-20 rotation regions). Given the original unwrapped label, the network may be trained to predict in which rotation region the optimal viewpoint lies. If the optimal viewpoint is in the first 20-degree rotation region, sample container 102 and/or sensor 408 may be rotated by approximately 20 degrees. If the optimal viewpoint is in the second rotation region, sample container 102 and/or sensor 408 may be rotated by approximately 40 degrees, and the like. The size of each rotation region may be adjusted based on the granularity needed (e.g., each rotation region may be larger than 30 degrees or smaller than 20 degrees). In some embodiments, a general convolutional neural network (CNN) may be used to perform the classification. Example architectures include Inception, ResNet, ResNeXt, DenseNet, or the like, although other CNN architectures may be employed.

For a regression model, a reference point may be chosen from the full revolution image (e.g., the unwrapped image), and the image may be assigned a label based on how much the imaged sample container has been rotated away from the reference position. With this information, the regression model may directly learn the relationship between amount of rotation of sample container 102 and/or sensor 408 and the optimal viewpoint. The current viewpoint then may be compared to the optimal viewpoint to determine how much additional rotation of sample container 102 and/or sensor 408 is needed. Note that the estimated additional rotation may not be very accurate when there is a large gap between the current viewpoint (of sensor 408) and the optimal viewpoint. Iterative applications may be employed until the viewpoint of sensor 408 converges to the optimal viewpoint (e.g., until the optimal viewpoint aligns with the center of view of sensor 408).

A deep learning network may include a feature-extraction portion followed by a task-specific portion. Segmentation network 508 includes a task-specific portion (also referred to as a segmentation section) that determines segmentations of the image (e.g., classification of every pixel in the image, wherein pixels within the same label are considered a “segment” of the image). The geometry of the segmentations in the image can be used to determine the ends of a label. The feature extraction section of segmentation network 508 extracts the most relevant features of the image for either segmentation or classification.

The feature-extraction section and the segmentation section of segmentation network 508 each include convolutional layers that process the image and its components. The feature-extraction section extracts the most relevant features of the image, such as edges, shapes, or the like, for either segmentation or classification. These features are not necessarily interpretable as is but may be used to generate the final result.

In some embodiments, a classification block may be included as a separate branch after the feature-extraction portion of segmentation network 508 and that trains a classifier with information obtained from the feature-extraction portion of segmentation network 508. These two tasks may be trained in parallel, or the segmentation block may be replaced with a classification block (as described below).

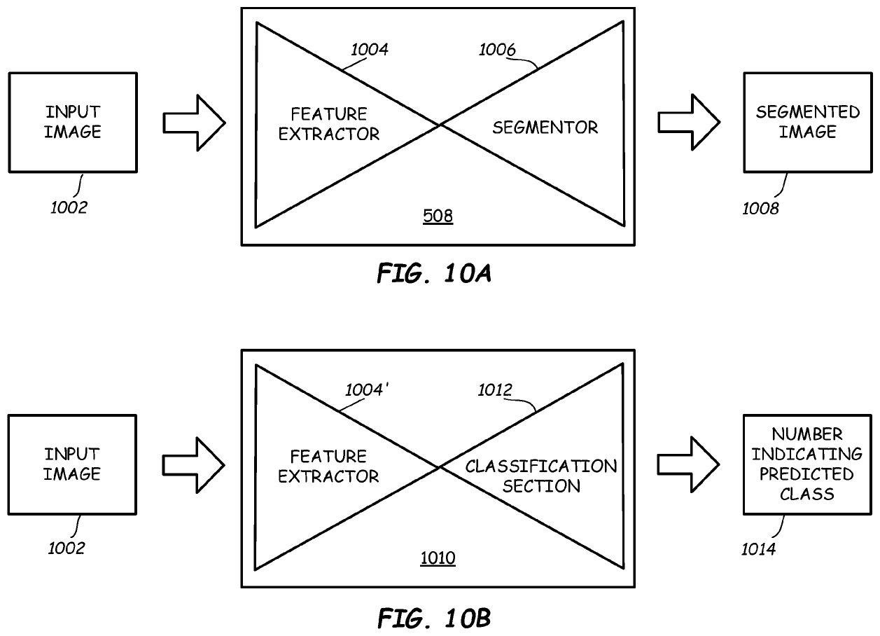

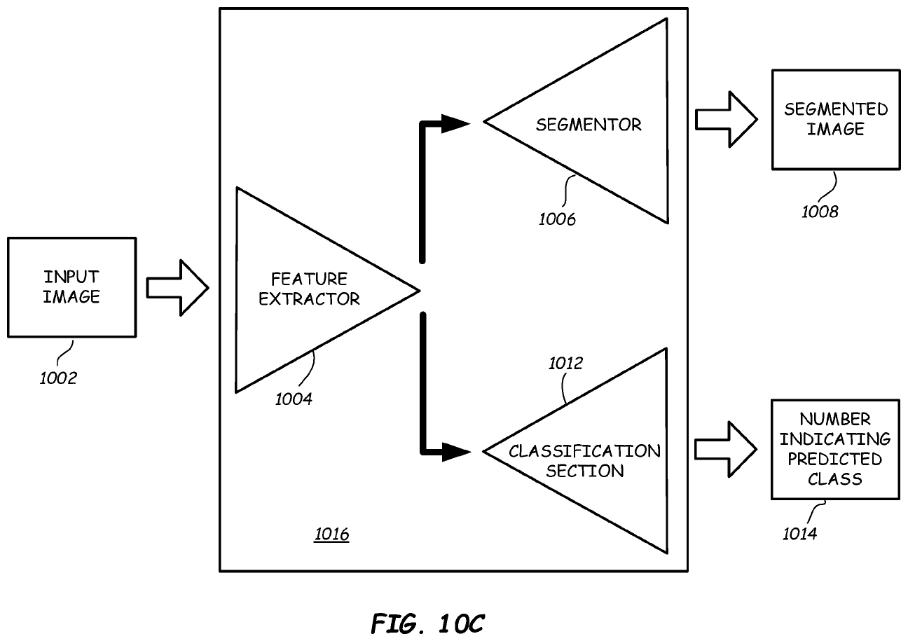

FIG. 10A-10C illustrate example embodiments of trained networks that may be employed with one or more embodiments provided herein. Specifically, FIG. 10A illustrates an embodiment of segmentation network 508 in which an input image 1002 is processed through a feature extractor 1004 which extracts image features from input image 1002. These image features are then fed into a segmentation section (e.g., segmentor 1006) of segmentation network 508 which classifies every pixel in the image and generates segmented image 1008 (e.g., such as segmentation mask 802 of FIG. 8).

FIG. 10B illustrates an embodiment of a classification network 1010 in which an input image 1002 is processed through feature extractor 1004′ which extracts image features from input image 1002. In some embodiments, the feature extractor 1004′ (FIG. 10B) employed by classification network 1010 may be similar to the feature extractor 1004 employed by segmentation network 508 (FIG. 10A), while in other embodiments, feature extractors 1004 and 1004′ may differ (e.g., employing different types, numbers, and/or arrangements of convolutions layers, using different training data sets, etc.).

The image features from feature extractor 1004′ are fed into a classification section 1012 of classification network 1010 which classifies the image features and identifies how far a sample container should be rotated. For example, classification section 1012 may provide a number 1014 indicating a predicted class that identifies the required range of rotation for aligning a label gap with a center of view of an imaging sensor. In some embodiments, classes may be divided into groups of approximately 10 degrees (0-10, 10-20, etc.) or another suitable group size (e.g., 5 degrees, 20 degrees, etc.) wherein the 360-degree rotation of sample container 102 is broken into discrete rotation regions (e.g., each 20 to 30 degrees to obtain approximately 10-20 rotation regions or the like).

FIG. 10C illustrates an embodiment of a segmentation and classification network 1016 in which both segmentor 1006 and classification section 1012 are included. For example, an input image 1002 is processed through feature extractor 1004 which extracts image features from input image 1002. These image features are then fed into both segmentor 1006 and classification section 1012 of segmentation network 508. Feature extractor 1004, segmentor 1006, and/or classification section 1012 may include any suitable number of convolution layers, for example.

Embodiments provided herein may employ a single sensor to capture the data. Additionally, a single rotating platform may be used to orient the sample container in front of the sensor. These improvements greatly reduce the size and cost of the setup. The image capture apparatus also may be made into a modular component and used in other workflows with little setup overhead, as well as to perform new analyses.

Embodiments provided herein ensure that the sample container is oriented correctly with respect to the sensor. The system analyzes the sample container to detect the optimal viewpoint and may adjust (e.g., rotate) the sample container to the optimal viewpoint. This relieves other parts of the system of the responsibility for correctly placing/orienting the sample container for analysis, and may improve the accuracy of the final analysis.

Additionally, embodiments provided herein accommodate variations in the placement of labels applied on the outside of a sample container. Label placement may be performed by a machine, in which case the label may be placed perfectly along an axis of the container, or by a human, who may introduce variations in the alignment. For such cases, the label may be skewed and cover different parts of the sample container as the label is wrapped around it. Labels also may not be in brand-new condition when they are applied; artifacts such as dirt, bunching of the label paper, tearing, and more may be present. The present system may be trained for these kinds of variations and still correctly predict the parts of the image that correspond to the label and which do not. This robustness provides a reliable result despite potential variations in label condition.

While the disclosure is susceptible to various modifications and alternative forms, specific method and apparatus embodiments have been shown by way of example in the drawings and are described in detail herein. It should be understood, however, that the particular methods and apparatus disclosed herein are not intended to limit the disclosure.

One or more of the methods described herein may be implemented in computer program code, such as part of an application executable on a computer, as one or more computer program products. Other systems, methods, computer program products and data structures also may be provided. Each computer program product described herein may be carried by a non-transitory medium readable by a computer (e.g., a DVD, a hard drive, a random-access memory, etc.).

Accordingly, while the present invention has been disclosed in connection with example embodiments thereof, it should be understood that other embodiments may fall within the spirit and scope of the invention, as defined by the following claims.

What is claimed is:

1. A method of determining a viewpoint for optically inspecting a sample within a sample container, comprising:
employing a sensor to capture image data of a sample container including a sample, wherein a portion of the sample container includes a label having a first end and a second end;
rotating at least one of the sample container and the sensor about a central axis of the sample container so that the sensor captures image data that includes at least the first end of the label and the second end of the label;
employing the captured image data to generate an unwrapped image of the sample container;
processing the unwrapped image to characterize the label and produce label characterization information; and
employing the label characterization information to identify a viewpoint through which to optically inspect the sample within the sample container.

2. The method of claim 1 wherein employing a sensor to capture image data includes capturing a plurality of images of the sample container at different viewpoints relative to the sample container.

3. The method of claim 2 further comprising employing two or more of the plurality of images to determine one or more of height, width, and diameter of the sample container.

4. The method of claim 1 wherein rotating at least one of the sample container and the sensor includes rotating at least one of the sample container and the sensor 360 degrees relative to one another.

5. The method of claim 1 wherein employing the captured image data to generate an unwrapped image of the label comprises stitching together a plurality of images of the sample container, each image depicting a different portion of the sample container.

6. The method of claim 5 wherein stitching together a plurality of images comprises:
obtaining an image window from each of the plurality of images, each image window including only a portion of the pixels of its respective image; and
stitching together the image windows from the plurality of images.

7. The method of claim 1 wherein processing the unwrapped image to characterize the label comprises generating a segmentation mask that characterizes the label by processing the unwrapped image through a trained segmentation network.

8. The method of claim 7 wherein the segmentation mask includes a plurality of pixels, wherein each pixel is identified as either a label pixel or a non-label pixel.

9. The method of claim 7 wherein employing the label characterization information to identify a viewpoint comprises employing the segmentation mask to identify a viewpoint by:
determining a center of a gap between the first and second ends of the label; and
determining how far to rotate the sample container to align the center of the gap between the first and second ends of the label and a center of view of the sensor.

10. The method of claim 1 further comprising inspecting the sample using the identified viewpoint.

11. The method of claim 10 further comprising characterizing the sample based on the inspection of the sample using the identified viewpoint.

12. An apparatus adapted to determine a viewpoint for optically inspecting a sample within a sample container, comprising:
a sensor configured to capture image data of a sample container including a sample, wherein a portion of the sample container includes a label having a first end and a second end;
a rotation mechanism configured to rotate at least one of the sample container and the sensor about a central axis of the sample container so that the sensor captures image data that includes at least the first end of the label and the second end of the label; and
a computer coupled to the sensor and the rotation mechanism, the computer including computer program code that, when executed by the computer, causes the computer to:
direct the rotation mechanism to rotate at least one of the sample container and the sensor about the central axis of the sample container so that the sensor captures image data that includes at least the first end of the label and the second end of the label;
employ the captured image data to generate an unwrapped image of the sample container;
process the unwrapped image to characterize the label and produce label characterization information; and
employ the label characterization information to identify a viewpoint through which to optically inspect the sample within the sample container.

13. The apparatus of claim 12 wherein the computer includes computer program code that causes the sensor to capture a plurality of images of the sample container at different viewpoints relative to the sample container.

14. The apparatus of claim 12 wherein the computer includes computer program code that generates an unwrapped image by stitching together a plurality of images of the sample container, each image depicting a different portion of the sample container.

15. The apparatus of claim 14 wherein the computer includes computer program code that generates an unwrapped image by:
obtaining an image window from each of the plurality of images, each image window including only a portion of the pixels of its respective image; and
stitching together the image windows from the plurality of images.

16. The apparatus of claim 12 wherein the computer includes computer program code that processes the unwrapped image to characterize the label by processing the unwrapped image through a trained segmentation network to generate a segmentation mask.

17. The apparatus of claim 16 wherein the segmentation mask includes a plurality of pixels, wherein each pixel is identified as either a label pixel or a non-label pixel.

18. The apparatus of claim 16 wherein the computer includes computer program code that employs the segmentation mask to:
determine a center of a gap between the first and second ends of the label; and
determine how far to rotate the sample container to align the center of the gap between the first and second ends of the label and a center of view of the sensor.

19. The apparatus of claim 12 wherein the computer includes computer program code that employs the sensor to inspect the sample using the identified viewpoint.

20. The apparatus of claim 19 wherein the computer includes computer program code that characterizes the sample based on the inspection of the sample using the identified viewpoint.

21. A diagnostic analysis system comprising:
a track;
a carrier moveable on the track and configured to contain a sample container including a sample, wherein a portion of the sample container includes a label having a first end and a second end;
a sensor configured to capture image data of the sample container;
a rotation mechanism configured to rotate at least one of the sample container and the sensor about a central axis of the sample container so that the sensor captures image data that includes at least the first end of the label and the second end of the label; and
a computer coupled to the sensor and the rotation mechanism, the computer including computer program code that, when executed by the computer, causes the computer to:
direct the rotation mechanism to rotate at least one of the sample container and the sensor about the central axis of the sample container so that the sensor captures image data that includes at least the first end of the label and the second end of the label;
employ the captured image data to generate an unwrapped image of the label;
process the unwrapped image to characterize the label and produce label characterization information; and
employ the label characterization information to identify a viewpoint through which to optically inspect the sample within the sample container.
